(19) United States
(12) Patent Application Publication
(10) Pub. No.: US 2005/0100315 A1
(43) Pub. Date: May 12, 2005

(54) Method of and apparatus for copying AV stream, and method of copying AV contents

(75) Inventors: Hee-chul Han, Suwon-si (KR); Yun-sang Kim, Suwon-si (KR); Yang-lim Choi, Seongnam-si (KR); Sung-hyu Han, Seoul (KR); Yong-kuk You, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/985,056

(22) Filed: Nov. 10, 2004

(30) Foreign Application Priority Data
Nov. 10, 2003 (KR) 03-79167

(51) Int. Cl. H04N 5/76

(52) U.S. Cl. 386/52; 386/94

(57) ABSTRACT

An audio and/or video (AV) stream copy method, an AV stream copy apparatus, and an AV contents copy control method, in which AV content includes an AV stream, are disclosed. The apparatus for copying an AV stream includes an AV stream copy controller, which, when an input copy command does not correspond to copy control information (CCI) of the AV stream, gives instructions to input a CCI coupon including new CCI, extracts the new CCI from the input CCI coupon, and gives instructions to copy the AV stream; a CCI coupon input unit, which inputs the CCI coupon according to a CCI coupon input command of the AV stream copy controller; and an AV stream copy unit, which changes the CCI of the AV stream, according to an AV stream copy command of the AV stream copy controller, and the extracted CCI and copies the AV stream.

### BACKGROUND OF THE INVENTION

This application claims priority from Korean Patent Application No. 2003-79167, filed on Nov. 10, 2003, in the Korean Intellectual Property Office, the disclosure of which is incorporated herein in its entirety by reference.

1. Field of the Invention

The present invention relates to an apparatus for copying digital data, and more particularly, to an apparatus for and a method of copying an audio/video data stream by changing copy control information of the audio/video data stream.

2. Description of the Related Art

Due to improvements in a digital signal processing technology, recording apparatuses and recording media which record information using a digital method are becoming increasingly popular. By using the digital recording apparatuses and recording media, recording/reproduction can be repeatedly performed while maintaining the quality of video/audio. Since audio and/or video (AV) streams can be repeatedly recorded/reproduced while AV quality is maintained, in a case where illegally copied recording media is circulated throughout the market, interests of licensers or legal distributors of media including contents, such as music and movies, are hurt. Lately, to prevent AV streams from being illegally copied, a plurality of methods of preventing illegal copying has been introduced to the digital recording apparatuses and recording media.

For example, in a minidisk (MD; trademark) player, a serial copy management system (SCMS) is adopted as a method of preventing illegal copying. SCMS prevents illegal copying by simultaneously outputting audio data and an SCMS signal from a digital interface (DIF) of a data reproduction side and controlling audio data recording of the data reproduction side in a data recording side with reference to the SCMS signal of the data reproduction side.

In particular, an SCMS signal indicates whether copying of the audio data is allowed infinitely, once, or never. If the data recording side receives the audio data from the DIF, the data recording side detects the SCMS signal that is simultaneously transmitted with the audio data. Accordingly, if the SCMS signal indicates that copying of the audio data is infinitely allowed, the audio data is recorded on an MD with the SCMS signal. If the SCMS signal indicates that copying of the audio data is allowed only once, the SCMS signal is changed to a state where copying is prohibited, and the changed SCMS signal is recorded in the MD with the audio data. If the SCMS signal indicates that copying of the audio data is not allowed, the audio data is not recorded. In the MD as described above, illegal copying of audio data with a copyright is prevented using the SCMS.

However, since the data recording side has an SCMS structure controlling the audio data recorded in the reproduction side based on the SCMS signal, if MD players without the SCMS structure are produced, it is difficult to manage the MD players. To resolve this problem, in DVD players, for example, illegal copying of data with a copyright is prevented using a contents scramble system.

In the contents scramble system, audio data and video data are encrypted and recorded in a DVD-ROM, and a key used for decrypting the encrypted data (a decryption key) is given to licensed DVD players. Therefore, in licensed DVD players, graphics and audio of the DVD-ROM can be reproduced using the given key.

Since a DVD player without a license does not have the key for decrypting the encrypted data, decryption of the encrypted data recorded in the DVD-ROM cannot be performed. That is, in the contents scramble system configuration, since DVD players that do not satisfy the conditions required in the license cannot reproduce the DVD-ROM in which an AV stream is recorded, illegal copying is prevented.

Copying conditions of contents are designated by contents providers in advance. Therefore, in a network, the designated conditions need to be exactly delivered to a device of the recording side. In the five-company digital transmission content protection (5C DTCP) system, which is a cooperative proposal of five leading companies, a copy control information (CCI) method is used.

An encryption mode indicator (EMI) has a mechanism sending the CCI using the upper 2 bits of a sync bit in a packet head, and since a receiving device can simply access the CCI and the CCI value acts on a key that encrypts contents, the contents can be safely delivered.

The CCI representing a copy control state of contents is recorded in an AV stream. That is, the CCI represents whether the contents can be copied and performs a contents protection function. The CCI is displayed with a 2-bit code and sets four types of modes. The CCI will now be described in further detail.

“Copy free” represents the CCI in a state where contents are not encrypted and can be copied freely. “Copy free but encrypted” represents the CCI in a state where contents are encrypted but can be copied freely. “Copy one generation” represents the CCI in a state where contents are encrypted but can be copied only once, and after the contents have been copied once, the state of the CCI is changed to “no further copying”. “Copying prohibited” represents the CCI in a state where contents are encrypted and can never be copied. The above description is shown in a table of FIG. 3.

A contents provider or a contents distributor determines a state of the CCI, and the determined state of the CCI is inserted and fixed in a header of an AV stream and transmitted to each device. A copy prevention module of a device, such as a home network server and a set-top box, parses the transmitted CCI state and operates a copy prevention process. The CCI determined by the contents provider or the contents distributor can never be changed.

In a conventional method, since a CCI state can never be changed after a contents provider or a contents distributor has determined the CCI state, a method of providing various services cannot exist.

For example, in general, a sales period of a movie is considered to be a certain duration period after a first run, i.e., about one to two weeks. After the duration period, a target of marketing should be changed to DVD sales.

That is, if an AV stream has been distributed in a state of “copying prohibited” since two months ago, the AV stream is considered not to be sold any more. At this time, a new business, such as selling a copyright, cannot be created without changing the CCI state.

### SUMMARY OF THE INVENTION

The present invention provides a method and an apparatus capable of selectively copying an AV stream by changing copy control information recorded in the AV stream.

According to an exemplary embodiment of the present invention, there is provided a method of copying an AV stream, the method comprising: when an input copy command does not correspond to CCI of the AV stream, inputting a CCI coupon including new CCI; and changing the CCI of the AV stream according to the new CCI extracted from the CCI coupon and copying the AV stream.

In the CCI coupon, a CCI identifier including the new CCI is encrypted.

The AV stream is copied only when the CCI identifier extracted by decrypting the CCI coupon corresponds to a CCI identifier of the AV stream.

The CCI coupon is input by being downloaded from the Internet.

The CCI coupon is input by being read from a recording medium.

The CCI coupon is input by a user's key input.

The CCI coupon is generated by encrypting the CCI identifier using a disc identifier, a device identifier, and a disc key.

The CCI coupon is generated by encrypting the CCI identifier using a disc identifier and a disc key.

The CCI coupon is generated by encrypting the CCI identifier using a device identifier and an open key of a copy device performing a copy job.

The CCI coupon is generated by encrypting the CCI identifier using an open key of a copy device performing a copy job.

According to another exemplary embodiment of the present invention, there is provided an apparatus which copies an AV stream, the apparatus comprising: an AV stream copy controller which, when an input copy command does not correspond to CCI of the AV stream, gives instructions to input a CCI coupon including new CCI, extracts the new CCI from the input CCI coupon, and gives instructions to copy the AV stream; a CCI coupon input unit which inputs the CCI coupon according to a CCI coupon input command of the AV stream copy controller; and an AV stream copy unit which changes the CCI of the AV stream according to an AV stream copy command of the AV stream copy controller and the extracted CCI and copies the AV stream.

In the CCI coupon, a CCI identifier including the new CCI is encrypted.

The AV stream copy controller gives instructions to copy the AV stream only when the CCI identifier extracted by decrypting the CCI coupon corresponds to a CCI identifier of the AV stream.

The CCI coupon input unit downloads the CCI coupon from the Internet.

The CCI coupon input unit reads the CCI coupon from a recording medium.

The CCI coupon input unit inputs the CCI coupon by a user's key input.

The CCI coupon is generated by encrypting the CCI identifier using a disc identifier, a device identifier, and a disc key.

The CCI coupon is generated by encrypting the CCI identifier using a disc identifier and a disc key.

The CCI coupon is generated by encrypting the CCI identifier using a device identifier and an open key of a copy device performing a copy job.

The CCI coupon is generated by encrypting the CCI identifier using an open key of a copy device performing a copy job.

According to another exemplary embodiment of the present invention, there is provided an AV contents copy control method of copying the AV contents including an AV stream, the method comprising: receiving a CCI coupon including CCI recorded in the AV stream, an identifier of the AV stream, and new CCI; extracting the identifier of the AV stream and the new CCI from the CCI coupon; comparing the identifier of the AV stream extracted from the CCI coupon and an original identifier of the AV stream; and when the extracted identifier of the AV stream is matched with the original identifier of the AV stream according to the comparison result, changing the CCI of the AV stream according to the new CCI extracted from the CCI coupon.

The identifier of the AV stream is one of an identifier recorded in the AV stream and an identifier of a recording medium in which the AV stream is recorded.

With the above configuration, CCI recorded in an AV stream can be changed and the AV stream can be selectively copied.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart of a method of copying an AV stream according to an exemplary embodiment of the present invention;

FIG. 2 is a schematic block diagram of an apparatus which copies an AV stream according to an exemplary embodiment of the present invention;

FIG. 3 is a table illustrating an exemplary embodiment of copy control information (CCI) codes and corresponding states of an AV stream;

FIG. 4 is a table illustrating an exemplary embodiment of codes and states of copy control information identifiers;

FIG. 5 illustrates an exemplary embodiment of inputting a CCI coupon generated by encrypting a CCI identifier using a disc identifier, a device identifier, and a disc key;

FIG. 6 illustrates an exemplary embodiment of inputting a CCI coupon generated by encrypting a CCI identifier using a disc identifier and a disc key;

FIG. 7 illustrates an exemplary embodiment of inputting a CCI coupon generated by encrypting a CCI identifier using a device identifier and an open key;

FIG. 8 illustrates an exemplary embodiment of inputting a CCI coupon generated by encrypting a CCI identifier using an open key;

FIG. 9 illustrates an exemplary embodiment of inputting a CCI coupon via the Internet;

FIG. 10 is a table illustrating an exemplary embodiment of a menu for buying a CCI coupon;

FIG. 11 illustrates an exemplary embodiment of inputting a CCI coupon by reading a recording medium or by a user's key input.

### DETAILED DESCRIPTION OF THE INVENTION

Hereinafter, with reference to the accompanying drawings, exemplary embodiments of the present invention will now be described.

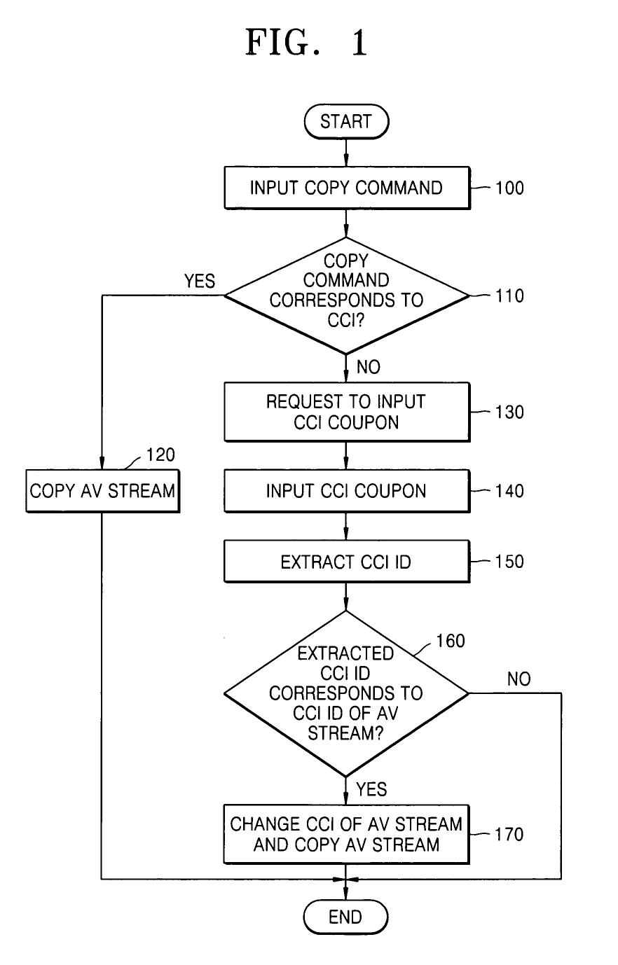

FIG. 1 is a flowchart of a method of copying an AV stream according to an exemplary embodiment of the present invention.

In operation 100, an AV stream copy command given by a user is input to an AV stream copy apparatus. A home network server or a set-top box may be used as the AV stream copy apparatus. The copy command includes a copy mode, and the copy mode is one of “copy free,” “copy free but encrypted,” and “copy one generation” of the CCI.

In operation 110, whether the input copy command corresponds to CCI of an AV stream is determined.

If it is determined that the input copy command corresponds to CCI of the AV stream, the AV stream is copied in the AV stream copy apparatus according to the CCI in operation 120.

If it is determined that the input copy command does not correspond to CCI of the AV stream, the AV stream copy apparatus requests to input a CCI coupon in operation 130. In operation 140, the CCI coupon, in which a new CCI ID is encrypted, is input to the AV stream copy apparatus. For example, when the CCI of the AV stream is “no further copying” or “copying prohibited”, if “copy one generation” as a copy command is input to the AV stream copy apparatus, an input of the CCI coupon is requested and accordingly, the CCI coupon is input to the AV stream copy apparatus.

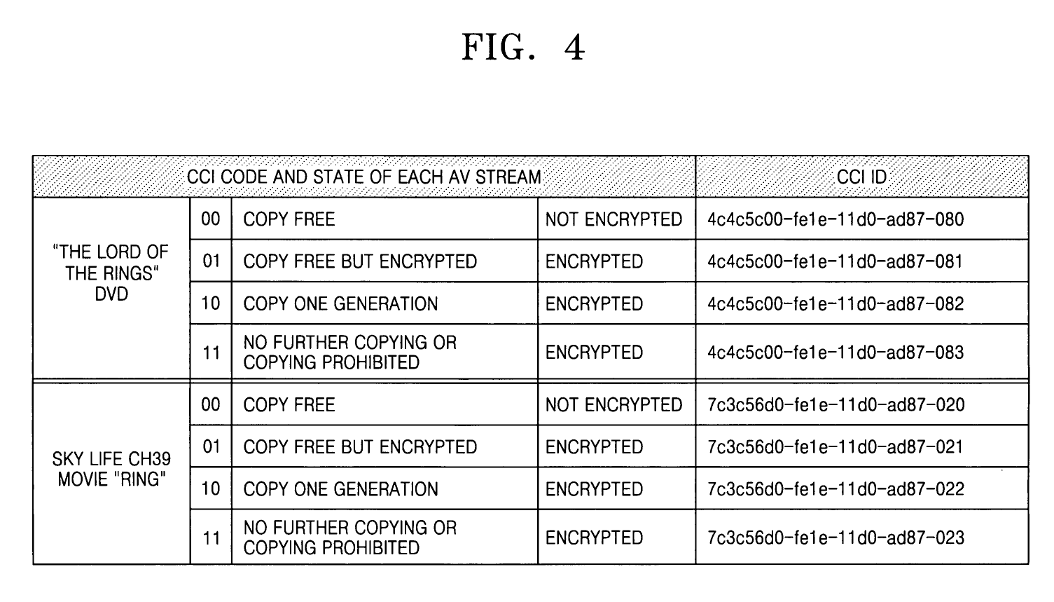

The CCI coupon is generated by encrypting a CCI identifier (ID). The CCI ID is private data that only a contents provider knows, and a last number of the CCI ID represents a CCI state. The CCI ID includes a plurality of identifiers not one identifier for one content as illustrated in FIG. 4.

FIG. 4 is a table illustrating CCI codes and states of AV streams, and CCI IDs corresponding to the CCI codes and states. As illustrated in FIG. 4, the AV stream can be a data stream recorded in a recording medium such as a DVD and a data stream broadcasted on a channel of a digital TV.

Several methods can be considered as a method of encrypting the CCI ID. The most preferable method uses a disc ID in which the AV stream is copied, a disc key, and a device ID of a copy device in which copying is performed. The disc ID and the device ID are used so that a CCI coupon is used for only a designated device and a designated disc. That is, disc binding and device binding are performed using the disc ID and the device ID.

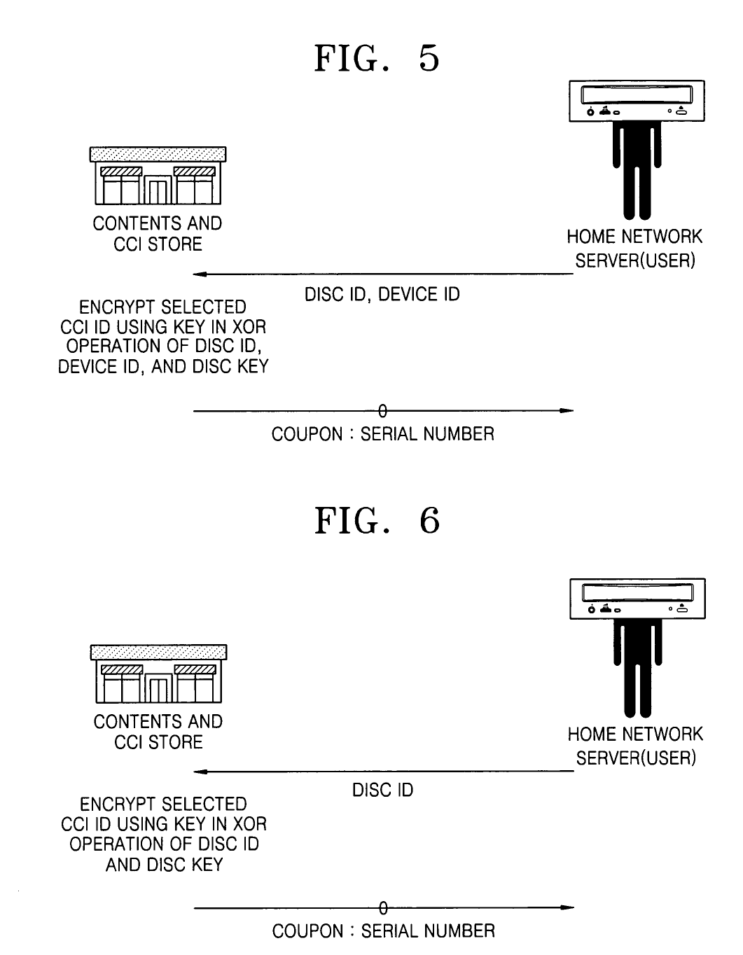

FIG. 5 illustrates that a contents store receives a disc ID and a device ID from a user, generates a CCI coupon by encrypting a CCI ID using the disc ID, a disc key, and the device ID, and transmits the generated CCI coupon to the user. In FIG. 5, the encryption method is an XOR operation and the CCI coupon is a serial number.

However, when both disc binding and device binding are not required, one of the disc binding process and device binding process can be performed, and encryption is performed using an open key of a copy device in which copying is performed.

When only disc binding is performed, the CCI coupon is generated by encrypting the CCI ID using the disc ID and the disc key, and when only device binding is performed, the CCI coupon is generated by encrypting the CCI ID using the device ID and the open key.

When only the open key is used, the CCI coupon is generated by encrypting the CCI ID using the open key, and a conventional open key algorithm is used for a method of using the open key and mutual security.

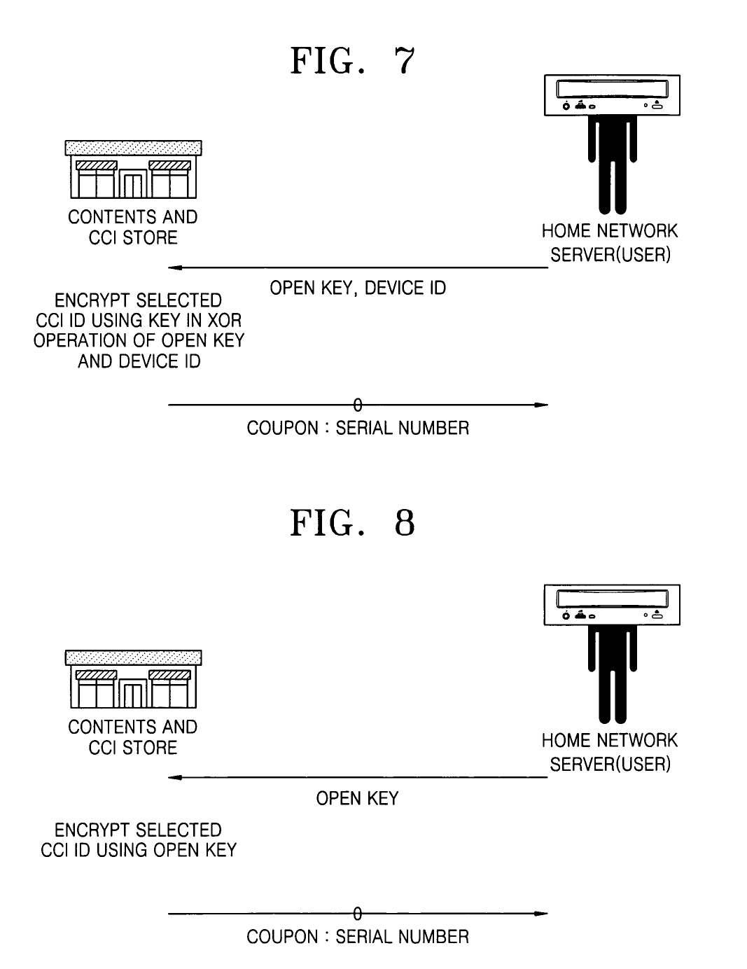

FIGS. 6, 7, and 8 schematically illustrate CCI coupon generation procedures using disc binding, device binding, and an open key, respectively.

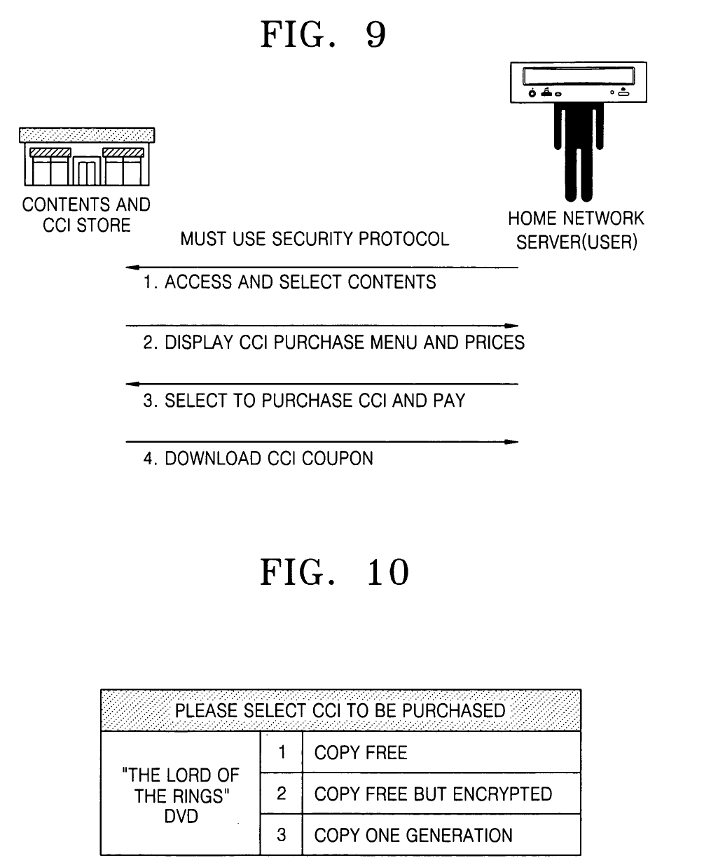

A CCI coupon can be downloaded from the Internet. FIG. 9 illustrates an exemplary embodiment of buying the CCI coupon from a CCI coupon generation server of a contents store via the Internet.

FIG. 9 illustrates an exemplary embodiment of a procedure where a user's home network server accesses the CCI coupon generation server of the contents store via the Internet and buys the CCI coupon.

First, if the user's home network server accesses the server of the contents store via the Internet and selects to purchase the CCI coupon, the server of the contents store displays a purchase menu and prices. FIG. 10 is an exemplary embodiment of a transmitted CCI coupon purchase menu display screen.

Next, the user's home network server transmits a disc ID and a device ID to the server of the contents store, and then the server of the contents store generates a serial number, i.e. a CCI coupon, that a CCI ID selected by the user is encrypted using a key generated in an XOR operation of the disc ID, the device ID, and a disc key and transmits the CCI coupon to the user's home network server. The downloaded CCI coupon can be stored in a predetermined storage device, such as a flash ROM, of the user's home network server.

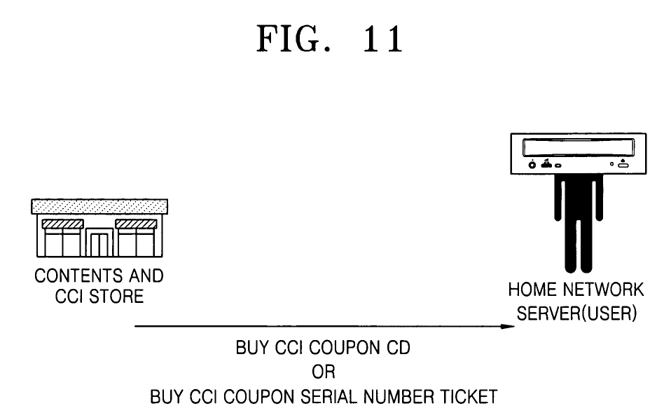

Also, in other exemplary embodiments, the CCI coupon can be input by reading a recording medium and by a user's key input. FIG. 11 schematically illustrates a process of inputting the CCI coupon by reading a recording medium and a process of inputting the CCI coupon by the user's key input.

When the CCI coupon is input by reading a recording medium, an install CD including a device ID, which is supplied to determine the device ID and a disc ID when a device is sold, and a CD to be copied are directly supplied to a contents store, the contents store supplies a recording medium, in which a CCI coupon is automatically stored using the two CDs, to a user, and a home network server reads the CCI coupon from the recording medium when an AV stream is copied.

When the CCI coupon is input by the user's key input, the contents store supplies a ticket, on which the CCI coupon is written, and not the recording medium in which the CCI coupon is recorded to the user, and the user directly inputs the CCI coupon using a key input device of the AV stream copy apparatus.

If the CCI coupon is input to the AV stream copy apparatus, the CCI coupon is decrypted and a CCI ID is extracted in operation 150. In operation 160, whether the extracted CCI ID corresponds to a CCI ID of the AV stream is determined.

CCI exists in a header of contents, and is usually encrypted. An encrypted CCI ID and the CCI are transmitted together as an auxiliary packet of the contents. As in a conventional method, the CCI is encrypted using a contents key, the contents key is encrypted using a device key of a device, and the encrypted CCI and the encrypted contents key are supplied with the contents.

The CCI ID is extracted by decrypting the CCI coupon using a CCI coupon key generated using the disc ID, the device ID, and the disc key. Whether the extracted CCI ID corresponds to the encrypted CCI transmitted with the AV stream is determined. Since the end portion of the CCI ID indicates a CCI state, the two states of the CCI can be compared.

Since the extracted CCI ID and the CCI ID included in the AV stream must be the same except for the CCI state, whether the two CCI IDs, except for the CCI state, are the same is determined.

When the extracted CCI ID does not correspond to the CCI ID included in the AV stream, the AV stream is not copied and the copying process is finished. When the extracted CCI ID corresponds to the CCI ID included in the AV stream, the CCI of the AV stream is changed according to the extracted CCI ID and the AV stream is copied in operation 170.

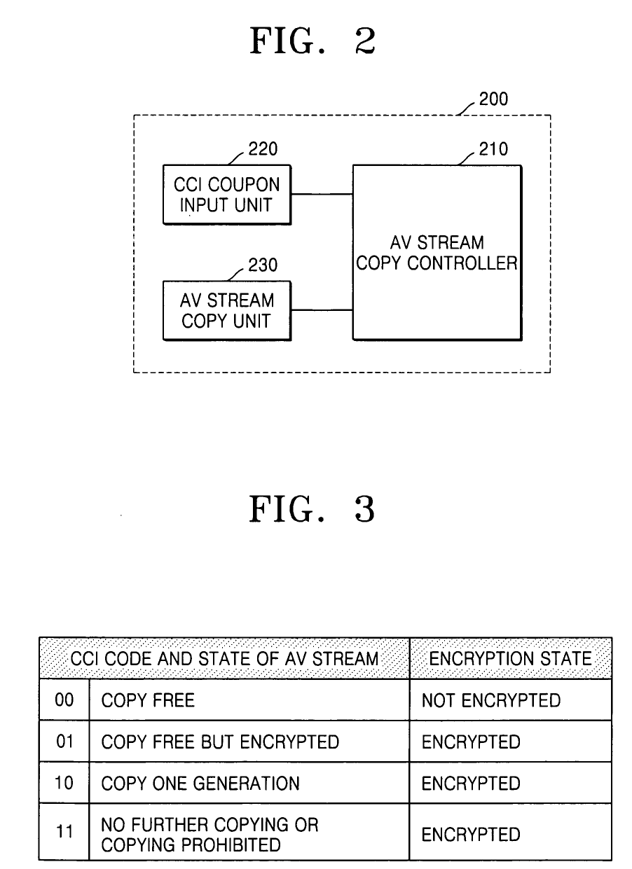

FIG. 2 is a schematic block diagram of an AV stream copy apparatus according to an exemplary embodiment of the present invention. With reference to FIG. 2, in the AV stream copy apparatus 200, an AV stream copy controller 210 is connected to a CCI coupon input unit 220 and an AV stream copy unit 230.

When an input AV stream copy command does not correspond to CCI of the AV stream to be copied, the AV stream copy controller 210 gives instructions to input a CCI coupon including newly encrypted CCI.

The copy command is input by a user. A home network server or a set-top box may be used as the AV stream copy apparatus 200. The copy command includes a copy mode, and the copy mode is one of “copy free,” “copy free but encrypted,” and “copy one generation” of the CCI.

The AV stream copy controller 210 determines whether the input copy command corresponds to CCI of an AV stream.

If it is determined that the input copy command corresponds to CCI of the AV stream, the AV stream copy controller 210 gives instructions to copy the AV stream according to the CCI.

If it is determined that the input copy command does not correspond to CCI of the AV stream, the AV stream copy apparatus 200 requests a CCI coupon and then receives the CCI coupon having an encrypted new CCI. For example, when the CCI of the AV stream is “no further copying” or “copy prohibited,” if “copy one generation” as a copy command is input to the AV stream copy apparatus 200, an input of the CCI coupon is requested, and accordingly, the CCI coupon is input to the AV stream copy apparatus 200.

The CCI coupon is generated by encrypting a CCI identifier (ID). The CCI ID is private data that only a contents provider knows, and the last number of the CCI ID represents a CCI state. The CCI ID includes a set of a plurality of identifiers as illustrated in FIG. 4 not one identifier.

FIG. 4 is a table illustrating CCI codes and states of AV streams and CCI IDs corresponding to them. As illustrated in FIG. 4, the AV stream can be a data stream recorded in a recording medium such as a DVD and a data stream broadcasted on a channel of a digital TV.

Several methods can be considered when encrypting the CCI. The most preferable method uses a disc ID in which the AV stream is copied, a disc key, and a device ID of a copy device in which a copy is performed. The disc ID and the device ID are used so that a CCI coupon is only used for a designated device and a designated disc. That is, disc binding and device binding are performed using the disc ID and the device ID.

FIG. 5 illustrates a contents store receiving a disc ID and a device ID from a user, generating a CCI coupon by encrypting a CCI ID using the disc ID, a disc key, and the device ID, and transmitting the generated CCI coupon to the user. In FIG. 5, the encryption method is an XOR operation and the CCI coupon is a serial number.

However, when both disc binding and device binding are not required, one of the disc binding and the device binding can be performed, and encryption is performed using an open key of a copy device in which copying is performed.

When only disc binding is performed, the CCI coupon is generated by encrypting the CCI ID using the disc ID and the disc key, and when only device binding is performed, the CCI coupon is generated by encrypting the CCI ID using the device ID and the open key.

When only the open key is used, the CCI coupon is generated by encrypting the CCI ID using the open key, and a conventional open key algorithm is used for a method of using the open key and mutual security.

FIGS. 6, 7, and 8 schematically illustrate CCI coupon generation procedures using disc binding, device binding, and an open key, respectively.

The CCI coupon is input to the CCI coupon input unit 220 according to a CCI coupon input command of the AV stream copy controller 210.

A CCI coupon can be downloaded from the Internet. FIG. 9 illustrates an exemplary embodiment of buying the CCI coupon from a CCI coupon generation server of a contents store via the Internet.

FIG. 9 illustrates an embodiment of a procedure of a user's home network server accessing the CCI coupon generation server of the contents store via the Internet and buying the CCI coupon.

First, if the user's home network server accesses the server of the contents store via the Internet and selects to purchase the CCI coupon, the server of the contents store displays a purchase menu and prices. FIG. 10 is an exemplary embodiment of a transmitted CCI coupon purchase menu display screen.

If the CCI coupon is input to the AV stream copy apparatus 200, the AV stream copy controller 210 decrypts the CCI coupon, extracts a CCI ID, and determines whether the extracted CCI ID corresponds to a CCI ID of the AV stream.

CCI exists in a header of contents and is usually encrypted. An encrypted CCI ID and the CCI are transmitted together as an auxiliary packet of the contents. As in a conventional method, the CCI is encrypted using a contents key, the contents key is encrypted using a device key of a device, and the encrypted CCI and the encrypted contents key are supplied with the contents.

The CCI ID is extracted by decrypting the CCI coupon using a CCI coupon key generated using the disc ID, the device ID, and the disc key. Whether the extracted CCI ID corresponds to the encrypted CCI transmitted with the AV stream is determined. Since the end portion of the CCI ID indicates a CCI state, the two states of the CCI can be compared.

Since the extracted CCI ID and the CCI ID included in the AV stream must be the same except for the CCI state, whether the two CCI IDs, except for the CCI state, are the same is determined.

When the extracted CCI ID does not correspond to the CCI ID included in the AV stream, the AV stream copy controller 210 gives instructions to finish the copying process and not to copy the AV stream. When the extracted CCI ID corresponds to the CCI ID included in the AV stream, the AV stream copy controller 210 gives instructions to copy the AV stream.

The AV stream copy unit 230 changes the CCI of the AV stream according to an AV stream copy command of the AV stream copy controller 210 and the extracted CCI ID and copies the AV stream.

Next, the user's home network server transmits a disc ID and a device ID to the server of the contents store, and then the server of the contents store generates a serial number, i.e. a CCI coupon, in which a CCI ID selected by the user is encrypted using a key generated in an XOR operation of the disc ID, the device ID, and a disc key and transmits the CCI coupon to the user's home network server. The downloaded CCI coupon can be stored in a predetermined storage device, such as a flash ROM, of the user's home network server.

Also, in other exemplary embodiments, the CCI coupon can be input by reading a recording medium and by a user's key input. FIG. 11 schematically illustrates a process of inputting the CCI coupon by reading a recording medium and a process of inputting the CCI coupon by the user's key input.

In the process of inputting the CCI coupon by reading a recording medium, an install CD including a device ID, which is provided to determine the device ID and a disc ID when a device is sold, and a CD to be copied are directly supplied to a contents store, the contents store supplies a recording medium, in which a CCI coupon is automatically stored using the two CDs, to a user, and a home network server reads the CCI coupon from the recording medium when an AV stream is copied.

In the process of inputting the CCI coupon by the user's key input, the contents store supplies a ticket, on which the CCI coupon is written, and not the recording medium in which the CCI coupon is stored to the user, and the user directly inputs the CCI coupon using a key input device of an AV stream copy apparatus 200.

The AV stream copy controller 210 decrypts the CCI coupon input via the CCI coupon input unit 220 and determines whether the extracted CCI ID corresponds to the CCI ID of the AV stream.

As described above, according to the present invention, an AV stream can be selectively copied by changing copy control information recorded in the AV stream. With the present invention, providers of AV contents, such as a movie, can supply various services by needs of the providers according to a proper moment.

Also, since the copy control information is encrypted and transmitted, illegal alterations of the copy control information are prevented.

While the present invention has been particularly described with reference to exemplary embodiments thereof, the present invention can be applied to various kinds of digital home appliances used for recording and reproducing an AV stream.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of copying an audio and/or video (AV) stream, the method comprising:
(1) receiving a copy command for copying the AV stream;
(2) inputting a copy control information (CCI) coupon including new CCI if the copy command does not correspond to CCI of the AV stream; and
(3) changing the CCI of the AV stream according to the new CCI included in the CCI coupon and copying the AV stream.

2. The method of claim 1, wherein in the CCI coupon, a CCI identifier including the new CCI is encrypted.

3. The method of claim 2, wherein step (3) is performed only when the CCI identifier extracted by decrypting the CCI coupon corresponds to a CCI identifier of the AV stream.

4. The method of claim 1, wherein in step (2), the CCI coupon is input by downloading from the Internet.

5. The method of claim 1, wherein in step (2), the CCI coupon is input by reading a recording medium.

6. The method of claim 1, wherein in step (2), the CCI coupon is input by a user key input.

7. The method of claim 2, wherein step (2) includes generating the CCI coupon which is input by encrypting the CCI identifier using a disc identifier, a device identifier, and a disc key.

8. The method of claim 2, wherein step (2) includes generating the CCI coupon which is input by encrypting the CCI identifier using a disc identifier and a disc key.

9. The method of claim 2, wherein step (2) includes generating the CCI coupon which is input by encrypting the CCI identifier using a device identifier and an open key.

10. The method of claim 2, wherein step (2) includes generating the CCI coupon which is input by encrypting the CCI identifier using an open key.

11. An apparatus for copying an audio and/or video (AV) stream, the apparatus comprising:
an AV stream copy controller, which, if an input copy command does not correspond to copy control information (CCI) of the AV stream, generates instructions to input a CCI coupon including new CCI, extracts the new CCI from the input CCI coupon, and generates instructions to copy the AV stream;
a CCI coupon input unit which inputs the CCI coupon according to a CCI coupon input command of the AV stream copy controller; and
an AV stream copy unit which changes the CCI of the AV stream according to an AV stream copy command of the AV stream copy controller and the new CCI extracted from the input coupon, and copies the AV stream.

12. The apparatus of claim 11, wherein in the CCI coupon, a CCI identifier including the new CCI is encrypted.

13. The apparatus of claim 12, wherein the AV stream copy controller generates the instructions to copy the AV stream only when the CCI identifier extracted by decrypting the CCI coupon corresponds to a CCI identifier of the AV stream.

14. The apparatus of claim 11, wherein the CCI coupon input unit downloads the CCI coupon from the Internet.

15. The apparatus of claim 11, wherein the CCI coupon input unit reads the CCI coupon from a recording medium.

16. The apparatus of claim 11, wherein the CCI coupon input unit inputs the CCI coupon by a user key input.

17. The apparatus of claim 12, wherein the CCI coupon is generated by encrypting the CCI identifier using a disc identifier, a device identifier, and a disc key.

18. The apparatus of claim 12, wherein the CCI coupon is generated by encrypting the CCI identifier using a disc identifier and a disc key.

19. The apparatus of claim 12, wherein the CCI coupon is generated by encrypting the CCI identifier using a device identifier and an open key.

20. The apparatus of claim 12, wherein the CCI coupon is generated by encrypting the CCI identifier using an open key.

21. An audio and/or video (AV) contents copy control method of copying the AV contents including an AV stream, the method comprising:
receiving a copy control information (CCI) coupon including CCI recorded in the AV stream, an identifier of the AV stream, and new CCI;
extracting the identifier of the AV stream and the new CCI from the CCI coupon;
comparing the identifier of the AV stream extracted from the CCI coupon and an original identifier of the AV stream; and
changing the CCI of the AV stream according to the new CCI extracted from the CCI coupon if the identifier of the AV stream extracted from the CCI coupon corresponds to the original identifier of the AV stream according to a comparison result.

22. The method of claim 21, wherein the identifier of the AV stream is one of an identifier recorded in the AV stream and an identifier of a recording medium in which the AV stream is recorded.
